(19) United States
(12) Patent Application Publication
(10) Pub. No.: US 2026/0267987 A1
(43) Pub. Date: Sep. 10, 2026

(54) Secure Deployment of Software Packages

(71) Applicant: ServiceNow, Inc., Santa Clara, CA (US)

(72) Inventors: Mark Russell MacEwen, La Jolla, CA (US); Kevin Scott Young, Temecula, CA (US); Carl Gerald Carreon, Chula Vista, CA (US); Kevin Karyadi, Santa Clara, CA (US)

(21) Appl. No.: 19/071,356

(22) Filed: Mar. 5, 2025

(51) Int. Cl. G06F 21/57; G06F 21/53; G06F 21/56

(52) U.S. Cl. CPC G06F 21/577; G06F 21/53; G06F 21/563

(57) ABSTRACT

Example embodiments may involve: retrieving, from a software artifact list within a quarantine subsystem, information relating to a software artifact; based on the information relating to the software artifact, retrieving the software artifact from a first artifact repository within a first computing system; causing a vulnerability checker within the quarantine subsystem to perform one or more vulnerability checks on the software artifact; determining that the software artifact is approved for deployment within a second computing system; and providing the software artifact to a second artifact repository, wherein the software artifact is deployable from the second artifact repository to the second computing system.

### BACKGROUND

Multi-instance environments are deployments that include two or more independent or semi-independent sets of computing infrastructure. Each such computational instance may include one or more processing nodes and one or more database nodes, as well as other components (e.g., switches, routers, load balancers, firewalls, etc.), and may perform the same and/or similar functions but for different end users or with different levels of security. For example, some computational instances may have higher security requirements than standard computational instances.

In order to avoid testing new and upgraded software in a high-security computational instance, a standard computational instance may be used for such tasks. When a software artifact (e.g., one or more compressed files containing executable images, dependencies, configuration files, build scripts, runtime information, and/or other data) is deemed sufficiently free of vulnerabilities (e.g., viruses, malware, and/or software defects), it may be deployed to the high-security computational instance for operation. However, it is challenging to facilitate this deployment in a fashion that is both efficient and secure.

### SUMMARY

Various implementations disclosed herein include technical improvements related to the secure deployment of software artifacts. Deploying software with security vulnerabilities to a computational instance can significantly degrade system performance by allowing malware to execute, unauthorized accesses, or exploits that consume computational resources (e.g., processor, memory, network, and/or power capacity). This leads to slowdowns, crashes, or even complete system failure. Additionally, vulnerabilities can be exploited for distributed denial of service (DDoS) attacks or unauthorized data exfiltration, further impacting efficiency and security.

Rather than pushing software artifacts from a standard computational instance to a high-security computational instance, it can be beneficial to employ an intermediate quarantine subsystem between the two. The standard computational instance can request that the quarantine subsystem facilitate deployment of a software artifact to a high-security computational instance. The quarantine subsystem can then pull a copy of the software artifact from the standard computational instance and perform vulnerability checking on the software artifact. With the results of the vulnerability checking in hand, the quarantine subsystem may obtain approval for deployment before deploying the software artifact to the high-security computational instance. A different but analogous procedure can be used by the quarantine subsystem to delete software artifacts that have been deployed in this fashion.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect involves a method that includes retrieving, from a software artifact list within a quarantine subsystem, information relating to a software artifact. The method also includes, based on the information relating to the software artifact, retrieving the software artifact from a first artifact repository within a first computing system. The method also includes causing a vulnerability checker within the quarantine subsystem to perform one or more vulnerability checks on the software artifact. The method also includes determining that the software artifact is approved for deployment within a second computing system. The method also includes providing the software artifact to a second artifact repository, where the software artifact is deployable from the second artifact repository to the second computing system. Other embodiments of this aspect include corresponding computer systems, apparatus, and computer programs recorded on one or more computer storage devices, each configured to perform the actions of the methods.

Another general aspect involves a method that includes retrieving, from a software artifact list within a quarantine subsystem, information relating to a software artifact, where the information relating to the software artifact was obtained from a first computing system. The method also includes, based on the information relating to the software artifact, determining that the software artifact is approved for deletion from a second computing system. The method also includes providing a deletion command to an artifact repository, where the deletion command causes the software artifact to be deleted from the artifact repository. The method also includes updating a further software artifact list within the first computing system to indicate that the software artifact is no longer deployable to the second computing system. Other embodiments of this aspect include corresponding computer systems, apparatus, and computer programs recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a quarantine architecture, in accordance with example embodiments.

FIG. 7 depicts a single standard computational instance and a single quarantine subsystem controlling the deployment of artifacts to multiple high-security computational instances, in accordance with example embodiments.

FIG. 8 is a message flow diagram for deployment of an artifact, in accordance with example embodiments.

FIG. 9 is a message flow diagram for deletion of a deployed artifact, in accordance with example embodiments.

FIG. 10 is a flow chart, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is the improvement of computer system security through the use of a quarantine subsystem to check software artifacts for vulnerabilities prior to deployment. Such vulnerabilities can consume computational resources (e.g., processor, memory, network, and/or power capacity), leading to slowdowns, crashes, or even complete system failure, as well as data exfiltration.

In other techniques, software is tested and then deployed should the test results indicating an acceptable level and nature of defects. However, these techniques do not take into account the increased attack surface provided by software artifacts, which can be packages of executable code, configuration data, and/or other information.

The embodiments herein overcome these limitations by employing an intermediate quarantine subsystem between a standard computational instance and a high-security computational instance. The quarantine subsystem can pull a copy of the software artifact from the standard computational instance and perform vulnerability checking on the software artifact. With the results of the vulnerability checking in hand, the quarantine subsystem may obtain approval for deployment before deploying the software artifact to the high-security computational instance. In this manner, the number of vulnerabilities in deployed software is reduced, resulting in less wastage of computing resources.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

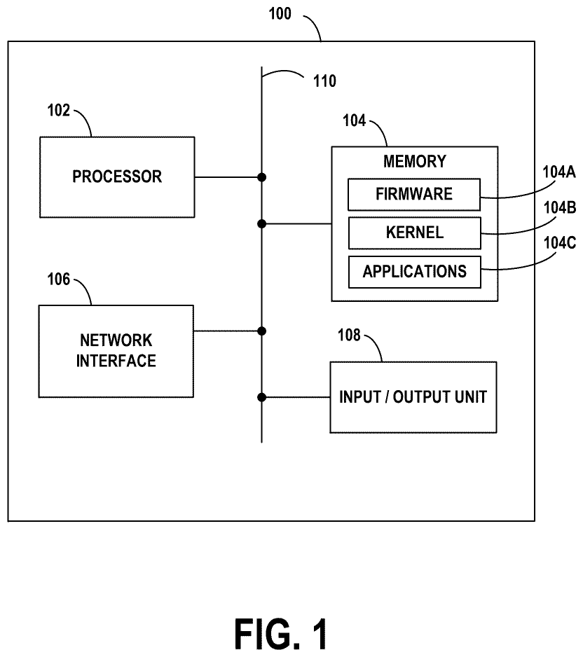

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

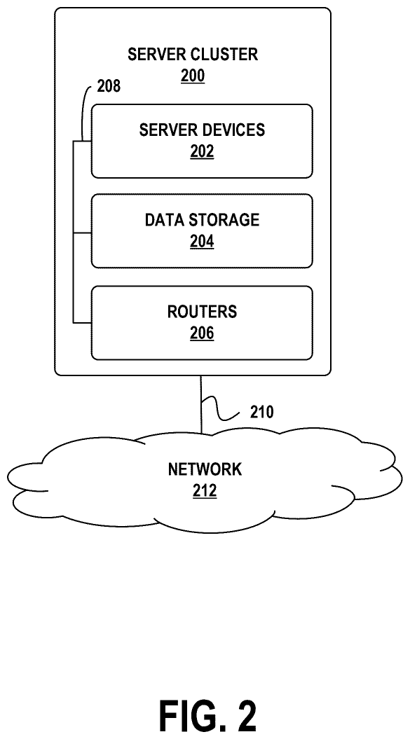

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

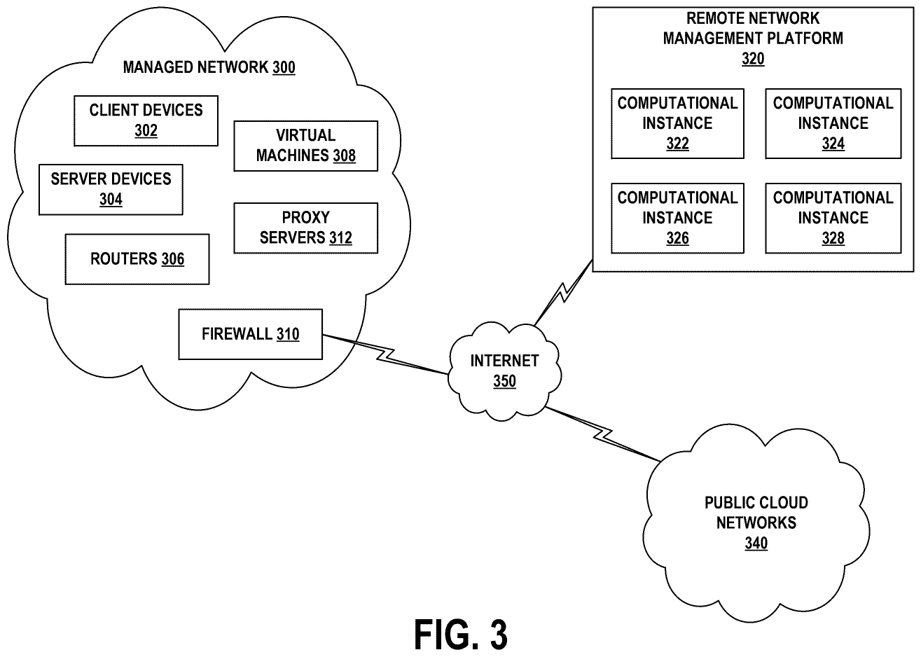

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers'data are separate from one another, the separation is enforced by the software that operates the single database. As a consequence, a security breach in this system may affect all customers'data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

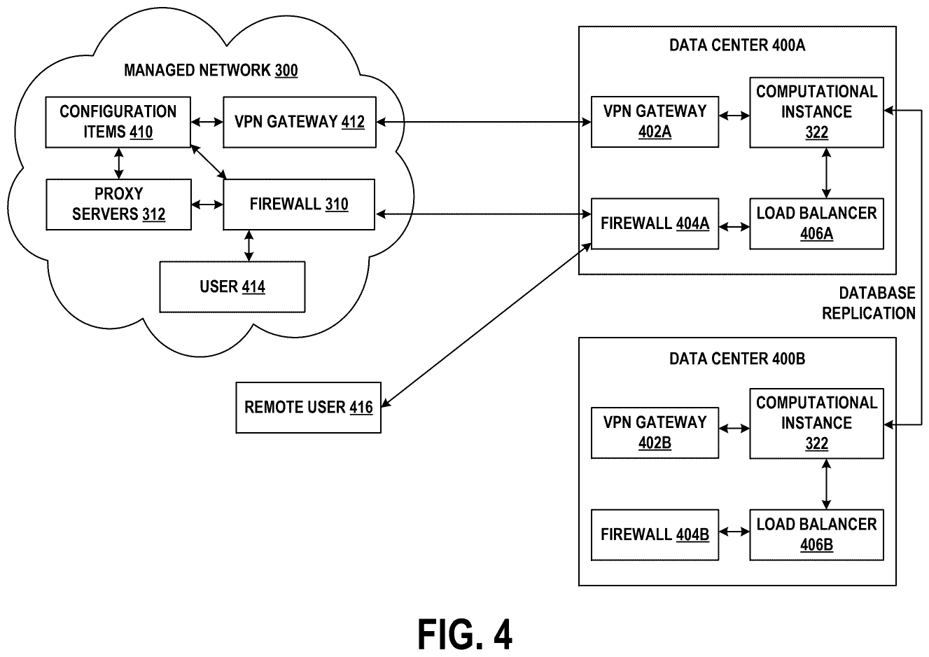

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

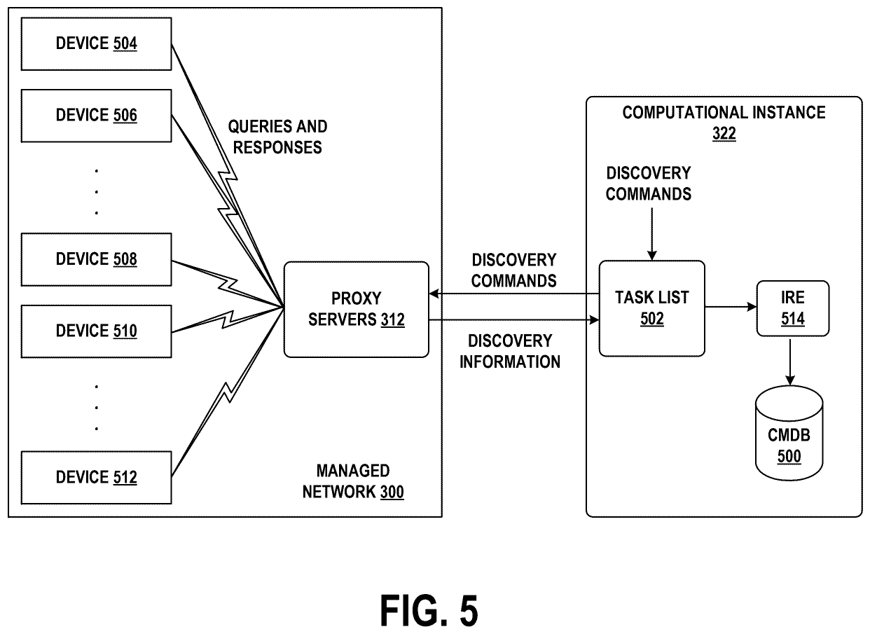

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Software Security in Multi-Instance Environments

Multi-instance environments are deployments that include two or more independent or semi-independent sets of computational instances or other computing infrastructure. Each computational instance may perform the same or similar functions, but for different end users or with different levels of security. As an example, computational instances used for public sector, financial, or medical purposes are more likely to contain personally identifiable information (PII) than computational instances used for commercial or consumer purposes.

Indeed, computational instances storing or with access to PII may be subject to an increased level of cyberattacks involving fraud, identify theft, ransomware, and/or other types of malware than standard computational instances. As a consequence, such computational instances may be subject to various types of regulatory requirements such as the Federal Risk and Authorization Management Program (FedRAMP) and Health Insurance Portability and Accountability Act (HIPAA) in the U.S., and/or General Data Protection Regulation (GDPR) in the European Union. These requirements may place certain types of controls over what data is stored, how it is stored, security procedures, and so on.

Nonetheless, these high-security computational instances are often based on the same or similar software as standard deployments. In many situations, software is developed and/or tested in a standard computational instance, then pushed to a high-security computational instance when it is deemed ready for deployment such an environment. Modern software packages are often bundled and distributed as artifacts-one or more compressed files containing executable images (source code and/or compiled binaries), dependencies, configuration files, build scripts, runtime information, and/or other data. But the introduction of incoming artifacts to high-security computational instances can greatly increase their attack surface while simultaneously making it difficult to track and control artifact deployments, status, and remediation. As a result, security becomes harder to facilitate in environments in which it is the most desirable.

The embodiments herein overcome these and possibly other technical problems by employing a quarantine zone between a standard computational instance and a high-security computational instance. Rather than pushing new or modified artifacts directly from the standard computational instance to the high-security computational instance, the artifacts are first stored in an artifact repository of the standard computational instance. A quarantine host within the quarantine zone can retrieve the artifact and perform a number of tests upon it. Only after these tests are passed and/or approval has been received can the artifact be pushed to the high-security computational instance. Doing so allows more granular control over artifact deployments and upgrades by allowing the high-security computational instance to control when and how the artifacts are tested, as well as what tests are performed.

Nonetheless, these techniques can be used to improve the security of artifact deployment between any two or more computational instances or computing systems. Accordingly, the terms “standard computational instance” and “high-security computational instance” may refer to any two computational instances, and may be colloquially named a first computational instance (providing the artifact) and a second computational instance (receiving the artifact after security checks), respectively.

### A. Artifacts and Deployment Thereof

Before discussing a possible quarantine architecture and associated message flows, it can be helpful to introduce several types of artifacts, their usage, and how they are deployed. Nonetheless, other types of artifacts may be used with embodiments herein.

Software artifacts can take the form of containers, Red Hat Package Manager (RPM) files, and other package formats facilitate software distribution, deployment, and execution across computing environments. As noted, these artifacts encapsulate executable images, dependencies, configuration files, build scripts, runtime information, and/or other data to provide consistency and portability of software delivery within and to these environments.

Containers, such as those created using Docker or Podman, package applications along with their dependencies, system libraries, and configurations into lightweight, portable runtime environments. They utilize containerization technologies like Linux namespaces and cgroups to isolate resources so that software applications execute consistently across different environments. Containers are deployed using container runtimes like Docker Engine or Kubernetes, which manage their lifecycle, networking, and orchestration. Unlike traditional virtual machines, containers share the host operating system, making them more efficient and faster to deploy.

RPMs are package files used primarily in Linux distributions. These packages contain compiled binaries, configuration files, and dependency metadata useful for software installation. They are managed through command line or graphical user interface tools that handle dependency resolution, updates, and verification using digital signatures for package integrity. RPMs follow a structured format with sections for metadata, scripts (pre-install, post-install), and payloads that extract files to appropriate filesystem locations.

Other package formats include Debian packages (.deb) for Debian and Ubuntu-based Linux systems, Python packages (.whl, .tar.gz) for managing Python libraries with pip or conda, and JAR/WAR files for Java applications deployed on JVM-based servers. Additionally, Helm charts are used for deploying Kubernetes applications, bundling Kubernetes manifests, and configurations for simplified orchestration of deployments.

Containers can be obtained from registries (e.g., Docker Hub, Red Hat Quay) and running them using docker, podman, or orchestrating them with Kubernetes. Other packages like RPMs, .deb files, Python, and Java packages are installed via package managers, while Kubernetes deployments use kubectl apply for manifests or Helm charts for streamlined management.

### B. Quarantine Architecture

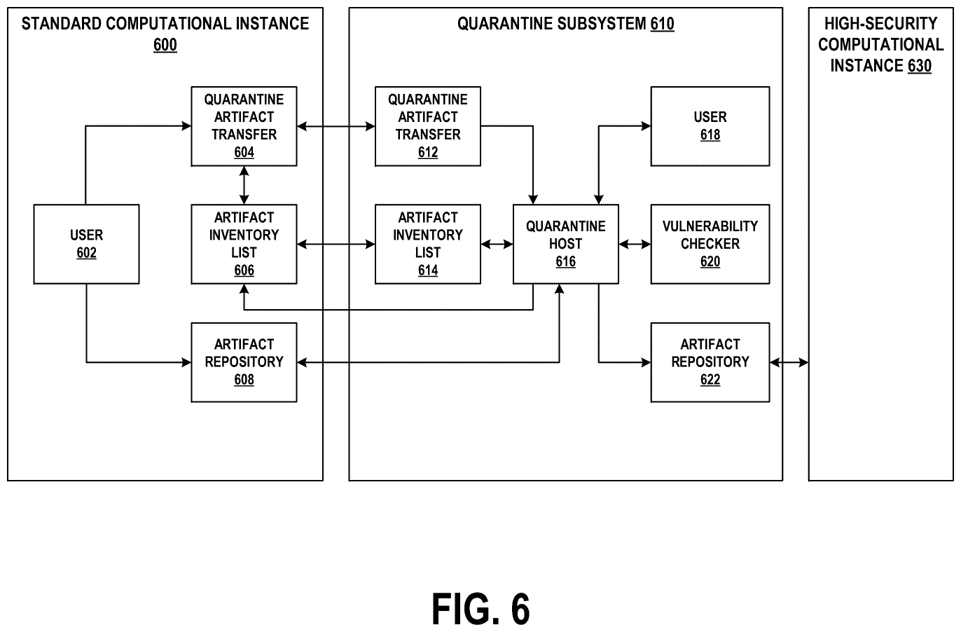

FIG. 6 depicts a quarantine architecture, in accordance with example embodiments. This architecture includes standard computational instance 600, quarantine subsystem 610, and high-security computational instance 630. Other computational instances, systems, devices, and components may be included. All computational instances may have the functionality and architecture of computational instance 322, for example.

Standard computational instance 600 includes quarantine artifact transfer application 604, artifact inventory list 606, and artifact repository 608. User 602 may interact with any of these components, such as quarantine artifact transfer application 604 and artifact repository 608 as shown.

Quarantine artifact transfer application 604 receives, stores, and manages requests for submitting artifacts for review by quarantine subsystem 610. As such, quarantine artifact transfer application 604 may include a graphical user interface through which user 602 can notify the application of an artifact stored in artifact repository 608 that is ready for review. Thus, quarantine artifact transfer application 604 may exist as a scoped application within standard computational instance 600.

Artifact inventory list 606 may be a database or be implemented as a database table that stores specific information about artifacts in artifact repository 608, such as their locations in this repository. Artifact inventory list 606 may store metadata regarding an incoming artifact (e.g., provided by user 602), its stage(s) in any relevant lifecycle process(es), and the current general state of the artifact (e.g., known vulnerabilities, where it has been deployed, and so on).

Artifact repository 608 may be a database or filesystem that stores artifacts. Artifact repository 608 may be configured so that artifacts can only be delivered to quarantine subsystem 610 upon request by quarantine host 616—in other words, artifacts can be pulled by quarantine subsystem 610 but not pushed to quarantine subsystem 610.

Some or all communications between standard computational instance 600 and quarantine subsystem 610 may take place through one or more firewalls. These firewalls may filter out any network traffic that does not match a preconfigured whitelist of network addresses (e.g., IP address) and/or port numbers, or otherwise fails a security check.

Quarantine subsystem 610 may serve as a security policy enforcement intermediary between standard computational instance 600 and one or more high-security computational instances. Quarantine subsystem 610 may include quarantine artifact transfer 612, artifact inventory list 614, quarantine host 616, vulnerability checker 620, and/or artifact repository 622. User 618 may interact with quarantine host 616 by way of a command line or graphical user interface.

Quarantine artifact transfer application 612 receives, stores, and manages requests for submitting artifacts for review by quarantine subsystem 610. Quarantine artifact transfer application 612 may obtain these requests from quarantine artifact transfer application 604, with the requests perhaps filtered by an intervening firewall. The transfer from quarantine artifact transfer application 604 to quarantine artifact transfer application 612 may occur automatically or manually. Automatic transfers may be triggered by quarantine artifact transfer application 604 receiving a request, based on a periodic time (e.g., once per minute), or based on some other mechanism.

Artifact inventory list 614 may be a database or be implemented as a database table that stores specific information about artifacts in artifact repository 608 that may or may not have been copied to artifact repository 622, such as their locations in these repositories. Artifact inventory list 614 may store any data stored in artifact inventory list 606, as well as support the ability to allow, block, or tag an artifact. For example, when an artifact is flagged as exhibiting a vulnerability, its entry in artifact inventory list 614 may be updated to indicate as such.

Quarantine host 616 may be a software application that manages operations of quarantine subsystem 610. In some cases, quarantine host 616 may be implemented as one or more executable scripts. This may include receiving requests from quarantine artifact transfer application 612, obtaining information regarding artifacts from artifact inventory list 614, running artifacts through vulnerability checker 620, and controlling which artifacts are populated into artifact repository 622. To do so, quarantine host 616 may receive requests and/or approvals from user 618 as needed (deployments on some high-security computational instances may require visual inspection of the software artifact, its metadata, and/or the vulnerability check results). Quarantine host 616 may provide one or more graphical user interfaces to support these functions, and may exist as a scoped application within remote network management platform 320.

Vulnerability checker 620 may include one or more software applications that scan artifacts for viruses, malware, coding defects (e.g., buffer overflows, SQL injection, cross-site scripting), configuration defects (improper privileges, weak passwords), or other types of vulnerabilities. Artifacts for which a vulnerability is detected may be tagged as such for further investigation. The exact type and combination of vulnerability scanners used are configurable per artifact, approving user, and the high-security computational instance intended for deployment.

Artifact repository 622 may be a database or filesystem that stores artifacts. Artifact repository 622 may be configured so that artifacts can only be received from or with the approval of quarantine host 616. Artifacts in artifact repository 622 that are not tagged as having vulnerabilities may be pushed to or retrieved by high-security computational instance 630. Alternatively, artifacts with known vulnerabilities may be deployed to high-security computational instance 630 if those vulnerabilities are deemed to be of an acceptable risk.

High-security computational instance 630 may be operated by the same entity as standard computational instance 600. Alternatively, high-security computational instance 630 could be operated by a different entity, e.g., it could be disposed within one of public cloud networks 340.

The communication interfaces between any of the components of FIG. 6, may be based on representational state transfer (REST) interfaces. A REST is an architectural style for designing networked applications that communicate over HTTP using standard methods such as GET, POST, PUT, DELETE, and PATCH. It can be stateless, meaning each request from a client to a server must contain all necessary information to complete the request, and the server need not store session state. REST APIs typically use JSON or XML for data exchange and rely on resource-based URLs (e.g., /users/{id}) to represent entities. They follow the principles of CRUD operations, where each HTTP method corresponds to creating, reading, updating, or deleting resources. Alternatives to REST interfaces include GraphQL (a query language that allows clients to request specific data), gRPC (a high-performance, binary protocol using HTTP/2 and Protocol Buffers), WebSockets (for real-time, bidirectional communication), and SOAP (a protocol using XML for structured messaging in web services). Any of these may be used with or instead of REST.

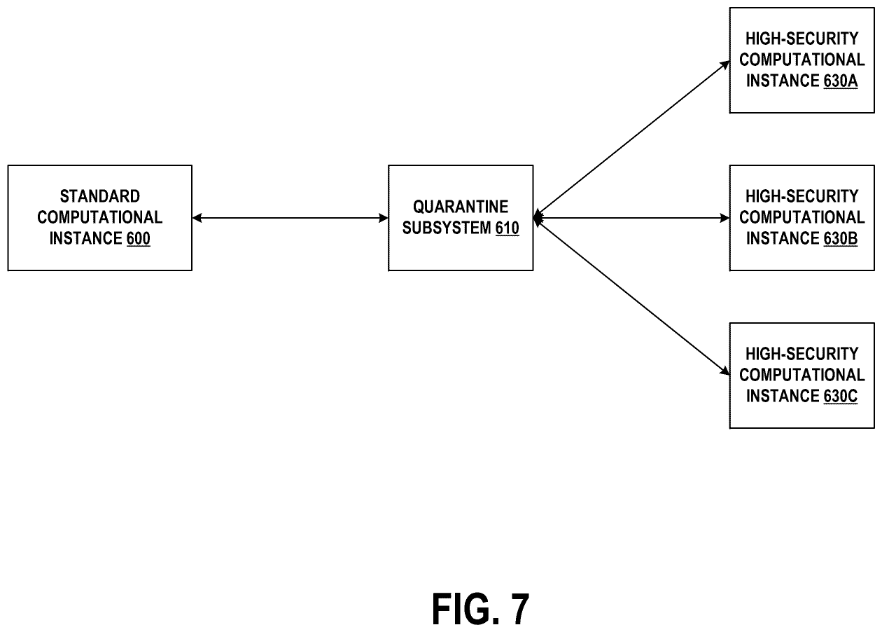

FIG. 7 depicts a single standard computational instance and a single quarantine subsystem controlling the deployment of artifacts to multiple high-security computational instances, in accordance with example embodiments. Particularly, standard computational instance 600 and quarantine subsystem 610 can be used to control deployment of artifacts to high-security computational instances 630A, 630B, and 630C. Quarantine subsystem 610 may be arranged to execute different vulnerability checks on artifacts depending on whether they are intended to be deployed on each of these high-security computational instances.

This overall architecture exhibits numerous technical advantages relating to modulatory. Quarantine subsystem 610 can mediate deployments between any two computing systems, facilitate review and approval of deployments by zero or more individuals, and support vulnerability checks for different types of vulnerabilities using vulnerability checking software for different vendors. Each software artifact can be in one of various formats and may be associated with different types of metadata.

### C. Quarantine Message Flows

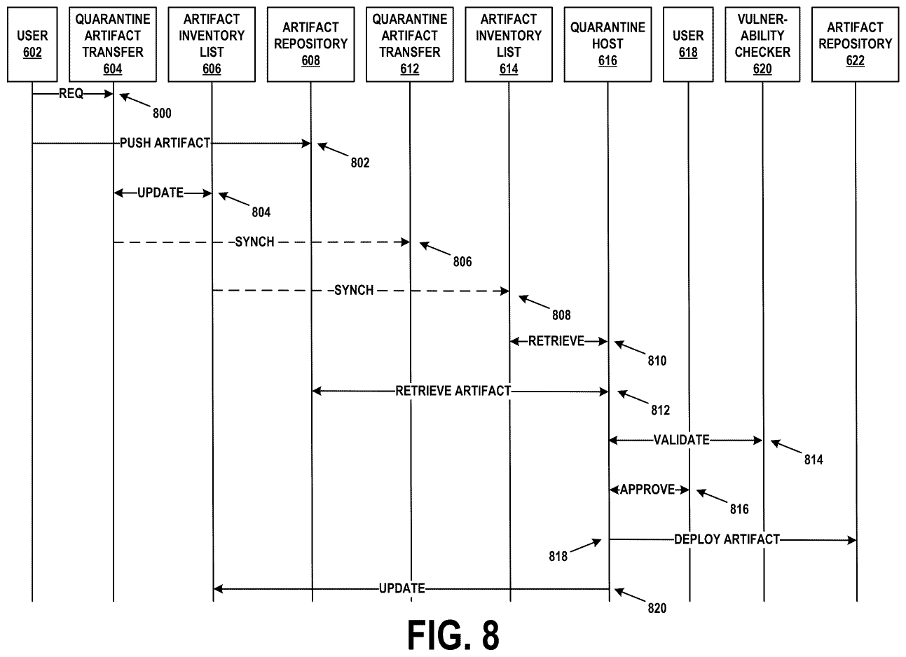

FIG. 8 depicts a message flow between the components introduced in the context of FIG. 6, in accordance with example embodiments. While this message flow involves the deployment of an artifact from standard computational instance 600 to high-security computational instance 630 by way of quarantine subsystem 610, other flows achieving the same or similar goals may be possible.

Step 800 may involve user 602 providing a request for artifact processing to quarantine artifact transfer application 604. This request may be by way of a command line or graphical user interface. Alternatively, it may be provided automatically without user intervention. The request may identify the artifact in some fashion (e.g., by a name or number of the artifact and/or using some other metadata).

Step 802 may involve user 602 pushing (e.g., transmitting or providing) the artifact to artifact repository 608 for storage. Alternatively, this step could be performed automatically without user intervention.

Step 804 may involve quarantine artifact transfer application 604 updating artifact inventory list 606 with information about the artifact, where it is stored, and other relevant metadata. In some cases, quarantine artifact transfer application 604 may cause a vulnerability pre-check (not shown) to be performed on the software artifact so that it's known vulnerabilities can be documented in artifact inventory list 606 or elsewhere.

Step 806 may involve quarantine artifact transfer application 604 synchronizing the request regarding the artifact with quarantine artifact transfer application 612. This may involve copying the request.

Step 808 may involve artifact inventory list 606 synchronizing the entries regarding the artifact with artifact inventory list 614. This may involve copying the entries.

Step 810 may involve quarantine host 616 retrieving the entries relating to the artifact from artifact inventory list 614. This step may occur manually in response to a user request or automatically (e.g., based on a schedule). In some cases, quarantine host 616 may first retrieve the request (not shown) from quarantine artifact transfer application 612 and using this request to determine that deployment has been requested for the artifact.

Step 812 may involve quarantine host 616 retrieving the artifact from artifact repository 608. This retrieval may be in accordance with information obtained in step 810 (e.g., the name, number, and/or location of the artifact).

Step 814 may involve quarantine host 616 providing the artifact to vulnerability checker 620. With the artifact, quarantine host 616 may also provide instructions for which vulnerability checks are to be performed.

Step 816 may involve quarantine host 616 providing information regarding the artifact (e.g., its name, number, location, and/or the high-security computational instance intended for its deployment) to user 618, and indicating that deployment of the artifact has been requested. If user 618 does not approve the deployment, the artifact may be deleted or sandboxed for further review.

Assuming that user 618 does approve the deployment, step 818 may involve quarantine host 616 providing the artifact to artifact repository 622 for deployment. From artifact repository 622 may be pushed to one or more high-security computational instances (not shown).

Step 820 may involve quarantine host 616 updating artifact inventory list 606 with the status of the artifact (e.g., where it is located, the outcome of the vulnerability checks, whether it was approved for deployment, and where it has been deployed). In some cases, the outcome of each of these steps may be logged at artifact inventory list 606 or elsewhere so that there is an accurate audit trail of the processing of the artifact.

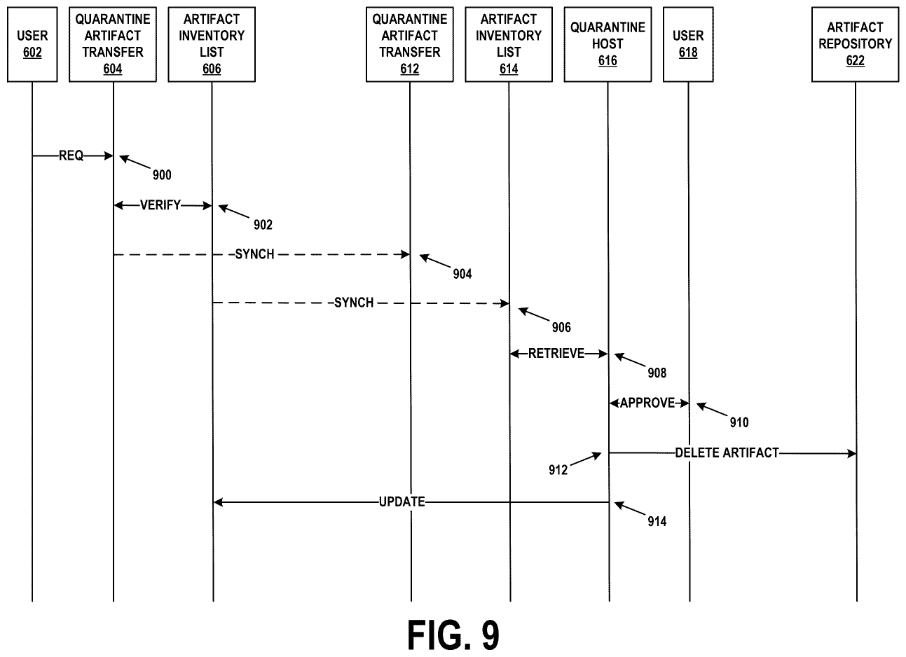

FIG. 9 depicts another message flow between the components introduced in the context of FIG. 6, in accordance with example embodiments. While this message flow involves the deletion of a deployed artifact from high-security computational instance 630 by way of quarantine subsystem 610, other flows achieving the same or similar goals may be possible.

Step 900 may involve user 602 providing a request for artifact deletion to quarantine artifact transfer application 604. This request may be by way of a command line or graphical user interface. Alternatively, it may be provided automatically without user intervention. The request may identify the artifact in some fashion (e.g., by a name or number of the artifact and/or using some other metadata).

Step 902 may involve quarantine artifact transfer application 604 verifying that artifact inventory list 606 contains information about the artifact, where it is stored, and other relevant metadata. The rest of the steps of this message flow assume that information about the artifact was found in artifact inventory list 606.

Step 904 may involve quarantine artifact transfer application 604 synchronizing the request regarding the artifact with quarantine artifact transfer application 612. This may involve copying the request.

Step 906 may involve artifact inventory list 606 synchronizing the entries regarding the artifact with artifact inventory list 614. This may involve copying the entries.

Step 908 may involve quarantine host 616 retrieving the entries relating to the artifact from artifact inventory list 614. This step may occur manually in response to a user request or automatically (e.g., based on a schedule).

Step 910 may involve quarantine host 616 providing information regarding the artifact (e.g., its name, number, location, and/or the high-security computational instance intended for its deployment) to user 618, and indicating that deletion of the artifact has been requested. If user 618 does not approve the deletion, the artifact's deployment may continue.

Assuming that user 618 does approve the deletion, step 912 may involve quarantine host 616 deleting the artifact from artifact repository 622. This may also cause deletion of the artifact from one or more high-security computational instances on which it has been deployed (not shown).

Step 914 may involve quarantine host 616 updating artifact inventory list 606 with the status of the artifact (e.g., that it has been deleted). In some cases, the outcome of each of these steps may be logged at artifact inventory list 606 or elsewhere so that there is an accurate audit trail of the processing of the artifact.

### VIII. Example Operations

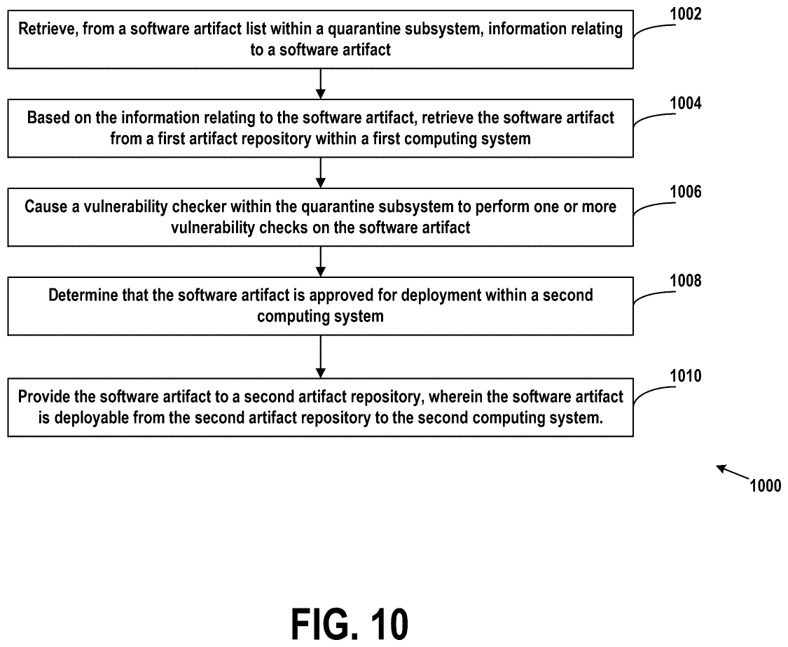

FIG. 10 is a flow chart illustrating an example embodiment. The process 1000 illustrated by FIG. 10 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 10 may be simplified by the removal of any one or more of the features shown therein. Further, these embodiments may be combined with features, aspects, and/or implementations of any of the previous figures or otherwise described herein.

Block 1002 may involve retrieving, from a software artifact list within a quarantine subsystem, information relating to a software artifact.

Block 1004 may involve, based on the information relating to the software artifact, retrieving the software artifact from a first artifact repository within a first computing system.

Block 1006 may involve causing a vulnerability checker within the quarantine subsystem to perform one or more vulnerability checks on the software artifact.

Block 1008 may involve determining that the software artifact is approved for deployment within a second computing system.

Block 1010 may involve providing the software artifact to a second artifact repository, wherein the software artifact is deployable from the second artifact repository to the second computing system.

These steps of checking the vulnerabilities of the software artifact provide a technical solution. As noted above, deploying software with vulnerabilities can lead to wastage of computing resources (e.g., processor, memory, network, and/or power capacity). By performing the vulnerability checks in a quarantine subsystem and deploying the software artifact only after it is approved for deployment, the likelihood of deploying software with vulnerabilities is mitigated.

In some embodiments, the second artifact repository is within the quarantine subsystem.

In some embodiments, the second artifact repository is within the second computing system.

In some embodiments, the software artifact list undergoes synchronization with a further software artifact list within the first computing system.

In some embodiments, the one or more vulnerability checks on the software artifact involve scanning the software artifact for viruses, malware, or other defects.

In some embodiments, determining that the software artifact is approved for deployment within the second computing system comprises determining that the one or more vulnerability checks performed on the software artifact have all passed.

In some embodiments, determining that the software artifact is approved for deployment within the second computing system comprises receiving an approval to deploy the software artifact from a user associated with the quarantine subsystem.

Some embodiments further comprise providing an update to a further software artifact list within the first computing system, wherein to the update indicates that the software artifact is deployable from the second artifact repository to the second computing system.

Some embodiments further comprise: retrieving, from the software artifact list, further information relating to the software artifact; determining that the software artifact is approved for deletion from the second computing system; providing a deletion command to the second artifact repository, wherein the deletion command causes the software artifact to be deleted from the second artifact repository; and updating a further software artifact list within the first computing system to indicate that the software artifact is no longer deployable to the second computing system.

In some embodiments, the software artifact comprises one or more of: executable images, dependencies, or configuration files.

In some embodiments, the vulnerability checker is configurable to perform different vulnerability checks based on one or more of: a type of the software artifact, the second computing system, or a user associated with the software artifact.

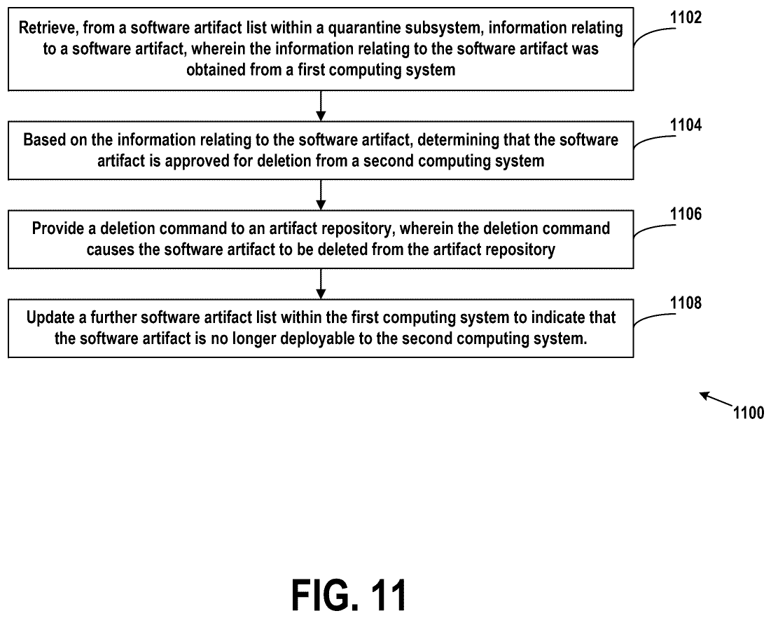

FIG. 11 is a flow chart illustrating an example embodiment. The process 1100 illustrated by FIG. 11 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

Block 1102 may involve retrieving, from a software artifact list within a quarantine subsystem, information relating to a software artifact, wherein the information relating to the software artifact was obtained from a first computing system.

Block 1104 may involve, based on the information relating to the software artifact, determining that the software artifact is approved for deletion from a second computing system.

Block 1106 may involve providing a deletion command to an artifact repository, wherein the deletion command causes the software artifact to be deleted from the artifact repository.

Block 1108 may involve updating a further software artifact list within the first computing system to indicate that the software artifact is no longer deployable to the second computing system.

These steps of removing a software artifact from being deployable provide a technical solution. Removing unused or deprecated software packages reduces disk space and main memory usage. It also avoids downloading, updating, or syncing unnecessary packages, reducing network load.

In some embodiments, the artifact repository is within the quarantine subsystem.

In some embodiments, the artifact repository is within the second computing system.

In some embodiments, the software artifact list undergoes synchronization with the further software artifact list.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
retrieving, from a software artifact list within a quarantine subsystem, information relating to a software artifact;
based on the information relating to the software artifact, retrieving the software artifact from a first artifact repository within a first computing system;
causing a vulnerability checker within the quarantine subsystem to perform one or more vulnerability checks on the software artifact;
determining that the software artifact is approved for deployment within a second computing system; and
providing the software artifact to a second artifact repository, wherein the software artifact is deployable from the second artifact repository to the second computing system.

2. The method of claim 1, wherein the second artifact repository is within the quarantine subsystem.

3. The method of claim 1, wherein the second artifact repository is within the second computing system.

4. The method of claim 1, wherein the software artifact list undergoes synchronization with a further software artifact list within the first computing system.

5. The method of claim 1, wherein the one or more vulnerability checks on the software artifact involve scanning the software artifact for viruses, malware, or other defects.

6. The method of claim 1, wherein determining that the software artifact is approved for deployment within the second computing system comprises:
determining that the one or more vulnerability checks performed on the software artifact have all passed.

7. The method of claim 1, wherein determining that the software artifact is approved for deployment within the second computing system comprises:
receiving an approval to deploy the software artifact from a user associated with the quarantine subsystem.

8. The method of claim 1, further comprising:
providing an update to a further software artifact list within the first computing system, wherein to the update indicates that the software artifact is deployable from the second artifact repository to the second computing system.

9. The method of claim 1, further comprising:
retrieving, from the software artifact list, further information relating to the software artifact;
determining that the software artifact is approved for deletion from the second computing system;
providing a deletion command to the second artifact repository, wherein the deletion command causes the software artifact to be deleted from the second artifact repository; and
updating a further software artifact list within the first computing system to indicate that the software artifact is no longer deployable to the second computing system.

10. The method of claim 1, wherein the software artifact comprises one or more of:
executable images, dependencies, or configuration files.

11. The method of claim 1, wherein the vulnerability checker is configurable to perform different vulnerability checks based on one or more of: a type of the software artifact, the second computing system, or a user associated with the software artifact.

12. A method comprising:
retrieving, from a software artifact list within a quarantine subsystem, information relating to a software artifact, wherein the information relating to the software artifact was obtained from a first computing system;
based on the information relating to the software artifact, determining that the software artifact is approved for deletion from a second computing system;
providing a deletion command to an artifact repository, wherein the deletion command causes the software artifact to be deleted from the artifact repository; and
updating a further software artifact list within the first computing system to indicate that the software artifact is no longer deployable to the second computing system.

13. The method of claim 12, wherein the artifact repository is within the quarantine subsystem.

14. The method of claim 12, wherein the artifact repository is within the second computing system.

15. The method of claim 12, wherein the software artifact list undergoes synchronization with the further software artifact list.

16. A non-transitory computer-readable medium, having stored thereon program instructions that, upon execution by a computing system, cause the computing system to perform operations comprising:
retrieving, from a software artifact list within a quarantine subsystem, information relating to a software artifact;
based on the information relating to the software artifact, retrieving the software artifact from a first artifact repository within a first computing system;
causing a vulnerability checker within the quarantine subsystem to perform one or more vulnerability checks on the software artifact;
determining that the software artifact is approved for deployment within a second computing system; and
providing the software artifact to a second artifact repository, wherein the software artifact is deployable from the second artifact repository to the second computing system.

17. The non-transitory computer-readable medium of claim 16, wherein the second artifact repository is within the quarantine subsystem.

18. The non-transitory computer-readable medium of claim 16, wherein the software artifact list undergoes synchronization with a further software artifact list within the first computing system.

19. The non-transitory computer-readable medium of claim 16, wherein determining that the software artifact is approved for deployment within the second computing system comprises:
determining that the one or more vulnerability checks performed on the software artifact have all passed.

20. The non-transitory computer-readable medium of claim 16, the operations further comprising:
retrieving, from the software artifact list, further information relating to the software artifact;
determining that the software artifact is approved for deletion from the second computing system;
providing a deletion command to the second artifact repository, wherein the deletion command causes the software artifact to be deleted from the second artifact repository; and
updating a further software artifact list within the first computing system to indicate that the software artifact is no longer deployable to the second computing system.
